(19) United States
(12) Patent Application Publication
(10) Pub. No.: US 2008/0041539 A1
(43) Pub. Date: Feb. 21, 2008

(54) Device for Separating Zones of a Room

(76) Inventor: Moritz Muehlebach, Dietlikon (CH)

Correspondence Address: ROBERTS, MLOTKOWSKI & HOBBES, P. O. BOX 10064, MCLEAN, VA, 22102-8064, US

(21) Appl. No.: 11/571,487

(22) PCT Filed: Apr. 26, 2005
(86) PCT No.: PCT/EP05/04456

§ 371 Date: Dec. 29, 2006

(30) Foreign Application Priority Data
Jul. 2, 2004 (DE) 10 2004 032 390.9

(51) Int. Cl. E06B 9/24

(52) U.S. Cl. 160/368.1

(57) ABSTRACT

A device for separating regions of a space which includes at least two ceiling rail parts for pressing against the ceiling of the space, the profile sections of the ceiling rail parts allowing adjacent parts to be inserted into and pulled apart from one another for adjusting the length of the ceiling rail. In like manner, the device includes a floor rail and at least one support rail extending between the ceiling rail and the support rail, each of which rails also has at least two rail parts which can be inserted into and pulled apart from one another for adjusting the length of the rails. In one embodiment, a ceiling rail, floor rail and two support rails form a peripheral rectangular frame with the rails in contact with the adjoining ceiling, floor and/or walls.

### BACKGROUND OF THE INVENTION

1. Field of the Invention

The invention relates to a device for the separation of zones of a space.

2. Description of Related Art

When manual activity such as renovation and repairs are carried out in buildings, the working area is often separated from other regions of the space, a residence, or the like, to prevent unhindered spreading of the dirt and dust which forms during manual activity and to reduce cleaning cost after completion of the work.

U.S. Pat. No. 5,924,469 discloses a device for separating regions of a space. The known device has a base element and a head piece, on one end of the base element there being a receiver for attaching a rod. The head piece is attached to the opposite end of the base element and has a fastener for fixing a web of film or material. The head piece can be inserted into the base element against the spring force of a spring means. To separate regions of a space, the device is first attached to one end of a rod, the rod together with the device having a length which is somewhat greater than the distance between the floor and ceiling of the space. Then, on the free end of the head piece, a film or material web is attached and the rod together with the device is set up between the floor and ceiling of the space so that the film or material web is pressed against the ceiling by the spring force of the spring means. Generally, to separate regions of a space it is necessary to set up several supports in the above described manner.

The disadvantage in the known device is that a certain “sagging” of the film or material web between the head pieces of two adjacent supports cannot be prevented, so that gaps form between the film or material web and the ceiling of the space through which especially fine dust can travel unhindered into the bordering region of the space. Other gaps can form with the known separation between the walls and the film or material web, which hangs down loosely there from the outer supports. Especially, wherever the supports cannot be set up in the in the immediate vicinity of the wall, gaps cannot be prevented between the film or material web and the wall. Ultimately only coarse dirt, but not fine dust which settles only slowly, can be retained.

### SUMMARY OF THE INVENTION

A primary object of this invention is, therefore, to provide a device which enables improved separation of regions of a space relative to dirt and dust.

The aforementioned object is achieved in a device wherein the ceiling rail parts can be inserted into one another and pulled out against one another making it possible to set the ceiling rail exactly to the width of the ceiling and, accordingly, to stretch a film to separate the regions of the space over the entire distance between two walls of a space in the immediate vicinity of the ceiling. For this reason, sagging of the film and thus formation of gaps between the film and ceiling of the space can be prevented. With the device as in accordance with the invention, at the same time, support of the film into the corner area between the ceiling and wall is possible so that even in the region of the walls the danger of gap formation can be reduced. Ultimately, the device as in accordance with the invention makes it possible to separate regions of a space from one another in a dust-tight manner by the gap-free attachment of a film to the ceiling and the walls of the space. Fouling by dirt, dust or the like can, therefore, be limited to the regions of a space which have been separated from one another.

In one alternative embodiment, it is provided that adjacent ceiling rail parts are securely joined to one another via at least one connecting means. Exact adjustment and matching of the length of the ceiling rail to the width of the ceiling can also be done via connecting means of varied length. Moreover it is also possible to provide ceiling rail parts of varied length which are then combined, as necessary, until the width of the ceiling, at least approximately, results. In this connection the individual ceiling rail parts are connected to one another so that a uniform ceiling rail results.

In conjunction with the device as in accordance with the invention, a film is defined as any flat piece of a plastic film, a textile, a nonwoven or a fabric which can be clamped using supports, frames and other fasteners to separate the regions of a space. In this connection it is irrelevant whether the film material is made from natural or synthetic fibers. However, those materials are preferred which are not only impermeable to air, but also impermeable to the dust to be retained by the separation of the regions of a space. In addition, it can be advantageous if the materials are transparent.

To support the ceiling rail in the immediate vicinity of the ceiling, in the device as in accordance with the invention, there can be at least one support rail which has at least two support rail parts, whereby adjacent support rail parts can preferably be inserted into one another and pulled apart from one another. By this configuration of the support rail it is ultimately possible to match the height of the support rail to the ceiling height of the space. In order to enable simple and prompt separation of regions of a space from one another and, at the same time, to ensure that the ceiling rail adjoins the ceiling of the space, it is fundamentally preferred that two support rails be provided to support the ceiling rail.

Alternatively, or in addition, to at least one support rail, there can be a floor rail which has at least two floor rail parts for resting on the floor. Here it is likewise advantageous if adjacent floor rail parts can be inserted into one another and pulled apart from one another. In this way fixing of the film used for separation, both along the ceiling and also along the floor, over the entire width of the region of space to be separated can be done. In this connection, the rail parts of the corresponding rail are pulled apart from one another sufficiently far that the rail ends adjoin the opposing walls.

In one preferred embodiment of the device as in accordance with the invention, it is provided that the ceiling rail, the two support rails and the floor rail in the mounted state form a peripheral rectangular frame, the outer support rails each adjoining the walls of the space. The rectangular frame can thus be mounted such that the film stretched along the frame adjoins the ceiling and also the walls and floor of the space, and dust or dirt cannot penetrate from the separated region of the space into the adjacent region of the space.

For simple installation and reducing production costs, it is fundamentally advantageous for the ceiling rail and the support rails and/or the floor rail to be made identically. With respect to simple installation, it is likewise advantageous if the ceiling rail and the floor rail have two different profile rails. In this connection, the profile rails may be made on the one hand as a base profile section and on the other as a connecting profile section. Here, the base profile section can be characterized in that two opposite sides are made to be connected to at least one connecting profile section at a time, and the connecting profile section can be inserted into the base profile section and can be withdrawn from the base profile section. However, it is also also possible to provide a uniform profile section type which enables insertion of two adjacent rails.

In order to be able to separate one region of a space as dust-tightly as possible from an adjacent region, on the ceiling rail, the support rail and/or the floor rail, on the outside, there can be a sealing means for contact with the ceiling of the space, the floor and/or the wall. Preferably the sealing means extends over the entire rail length and consists, especially, of an elastic, preferably foamed plastic or rubber.

In order to prevent unintentional sliding of the parts of the ceiling rail, the support rail and/or the floor rail into one another, especially in the installed state, it is advantageous if at least one rail part has a fixing means for fixing the rail part to another rail part relative to one another. It goes without saying that the other rail part can also have a fixing means so that any number of rail parts can be connected to one another. Here, it is especially advantageous if one rail part has two fixing means so that two adjacent rail parts can be fixed relative to one another on this rail part. The ceiling rail, the support rail and/or the floor rail can be assembled from any plurality of rail parts in order to achieve the desired rail length. In such a case the rail parts (connecting profile sections) which always have fixing means alternate with rail parts without fixing means (base profile sections).

The individual rail parts can fundamentally be fixed by connections known from the prior art. For simple installation and simple dismantling, however, catch, clamp, screw or squeeze connections are recommended.

To ensure the stability of the frame composed of a ceiling rail, two support rails and one floor rail, the support rails, in the installed state, can be connected via at least one corner connector to the ceiling rail and/or floor rail. The corner connector has preferably at least one spring means with a spring force which opposes the approach of the two lengthwise ends of the corner connector to one another. As a result, the rails connected to the corner connector are pretensioned in the direction toward the wall, ceiling or floor.

In order to facilitate installation of a frame composed of several rails, in one preferred embodiment of the invention, there is a foot part for connection to the floor rail. The frame can be kept in the vertical position during installation by the foot part. In order to be able to easily remove the foot part after installing the frame, the foot part can be made to be inserted or suspended in the floor rail.

To ensure sufficient stability, the foot part, when connected to the floor rail, should extend transversely to the floor rail over a length which is preferably between 1 m and 2 m, especially about 1.4 m. The foot part should, in other words, be in contact with the floor over a distance from 1 m to 2 m, preferably about 1.4 m.

The device as in accordance with the invention, in one preferred embodiment, enables not only separation of one region of space in one plane, but also over a corner. For this purpose it is provided that at least one rail part, which is preferably the connecting profile section, has a bevel on at least one lengthwise end. It has proven especially favorable if the bevel has roughly an angle of 45° to the lengthwise sides of the rail part so that two adjacent rails with adjoining bevels form a right angle.

For the sake of simple installation, in conjunction with the device as in accordance with the invention, it is recommended that the rail parts have different standardized lengths. The length of the connecting profile section can be fundamentally between 50 mm and 500 mm, preferably between 100 mm and 300 mm. Conversely, it is advantageous if the base profile section has a length between 1 m and 3 m, a length of about 1.5 m being preferred.

In conjunction with the device as in accordance with the invention, it has been found that a good compromise between lightness and stiffness of the rail parts is achieved when the height and/or width of the rail parts is between 15 mm and 55 mm, preferably about 30 mm. With respect to weight it is furthermore advantageous if the rail parts are made from aluminum.

Other features of the invention will become apparent from the following description and accompanying drawings.

### BRIEF DESCRIPTION OF THE DRAWINGS

FIG. 1 is a perspective view of one preferred embodiment of the device as in accordance with the invention.

FIG. 2 is a cross sectional view of the ceiling rail taken along the plane II-II in FIG. 1.

FIGS. 3a & 3b show the details of the fixing of the rail parts of the ceiling rail in FIG. 1.

FIGS. 4a & 4b are side views of a corner connector in the installed state,

FIG. 4c is a cross-sectional view of a support rail and a corner connector taken along the plane III-III in FIG. 4a.

FIG. 5 is a cross-sectional view of the floor rail in FIG. 1 connected to a foot part FIG. 6 is a top view of one preferred embodiment of a ceiling rail part.

### DETAILED DESCRIPTION OF THE INVENTION

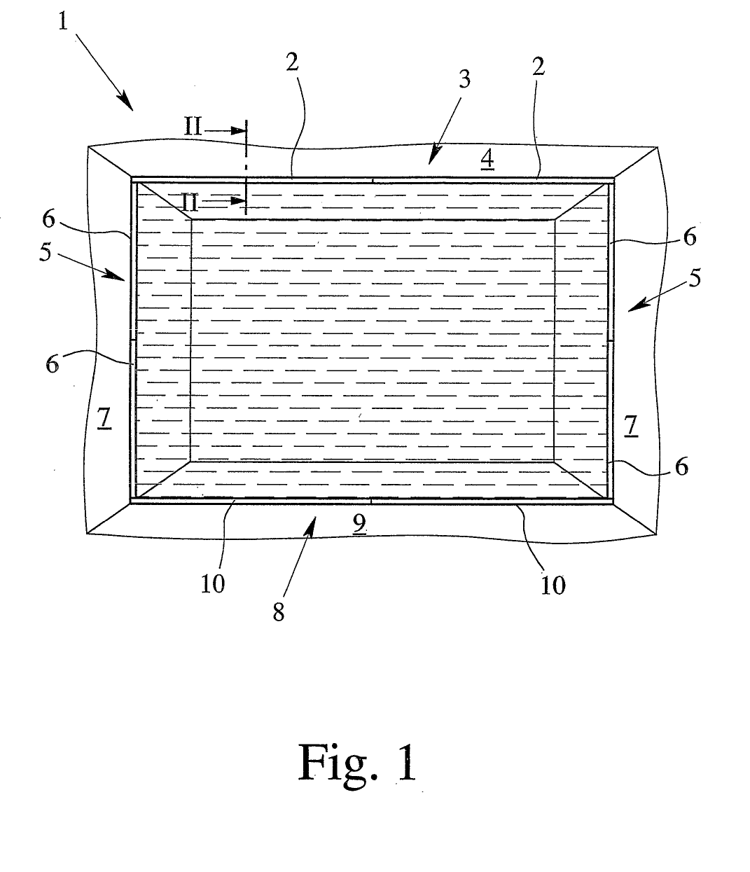

FIG. 1 shows a device 1 for separating the regions of a space (zones of a room) with a ceiling rail 3 which has two ceiling rail parts 2 for pressing against the ceiling 4 of the space. In this connection, the ceiling rail parts 2 have a profile section such that adjacent ceiling rail parts 2 can be inserted into one another and pulled apart from one another. In the illustrated ceiling rail 3, the ceiling rail parts 2 are pulled apart from one another sufficiently that the ceiling rail 3 extends over the entire width of the ceiling 4 of the space. The ceiling rail 3 is pressed over its entire length against the ceiling 4 of the space and thus adjoins the ceiling 4 of the space along the entire length of the ceiling rail 3.

In an embodiment which is not shown, adjacent ceiling rail parts are connected to one another via connecting elements so that a uniform or integral ceiling rail results. The connection between the adjacent ceiling rail parts can be such that, in contrast to the above described embodiment, relative displacement between the adjacent ceiling rail parts is not possible. Adaptation to the width of the ceiling then takes place via ceiling rail parts of different length, which can be made available as a set.

Furthermore, FIG. 1 shows two support rails 5 for supporting the ceiling rail 3. The support rails 5 each have two support rail parts 6 which, similarly to the ceiling rail 3, can be inserted into one another and pulled apart from one another. The support rails 5, on the one hand, perform the task of pressing the ceiling rail 3 against the ceiling 4 of the space and, on the other hand, adjoin the walls 7 over the entire length of the support rails 5.

Moreover, FIG. 1 shows a floor rail 8, which has two floor rail parts 10, for resting on the floor 9. Floor rail parts 10 can also be inserted into one another and pulled apart from one another. Therefore, FIG. 1 shows a ceiling rail 3, two support rails 5 and a floor rail 8 which together are mounted to form a peripheral right-angle frame 11. The dimensions of the frame 11 are selected such that the right-angled frame peripherally adjoins the ceiling 4, the walls 7 and the floor 9 of the space. In this connection it is important that the frame 11 can be easily matched to different sizes of a space, in which the rail parts 2, 6, 10 are pulled out against one another or inserted into one another such that the length of the ceiling rail 3 and the floor rail 8 correspond to the distance between the walls 7 and the length of the support rails 5 to the height of the walls 7.

It will be appreciated that, for very large regions of space to be separated, the rails 3, 5, 8 can also have three and more rail parts 2, 6, 10. Alternatively or in addition, it is of course also possible to use rail parts 2, 6, 10 which have different, preferably standardized, lengths so that depending on the spatial dimensions rails 3, 5, 8 with different maximum and minimum lengths are available. By using rail parts 2, 6, 10 in a corresponding number and length, ultimately regions of a space of any size can be separated. It will also be appreciated that the ceiling rail 3, the support rail 5 and the floor rail 8 may be identically structured.

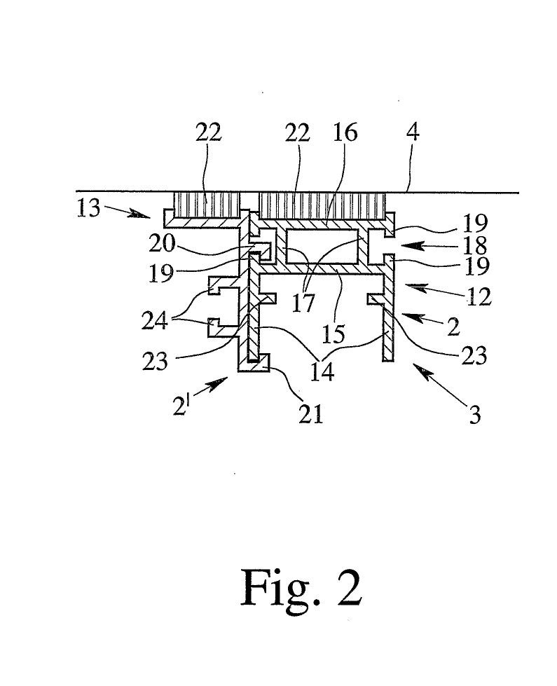

FIG. 2 shows one embodiment of the ceiling rail 3 from FIG. 1 in a cross section taken along the plane II-II. The illustrated structure of the ceiling rail 3 corresponds identically to the structure of the support rail 5 and the floor rail 8. The illustrated ceiling rail 3 consists of two different ceiling rail parts 2, 2′, their being a base profile section 12 and a connecting profile section 13. The base profile section 12 is essentially a U-shaped profile section, the shape being formed by two braces 14 located on the outer lengthwise sides and a cross brace 15 which connects the two braces 14. Parallel to the cross brace 15 there is another cross brace 16 which is connected to the cross brace 15 via crosspieces 17 located at right angles to the cross brace 16. The crosspieces 17 and braces 14 are spaced apart from one another in the lengthwise direction. Since, likewise, the cross brace 16 is spaced apart from the braces 14, a groove 18 which runs along the lengthwise direction of the base profile section 12 is formed. On the outside edges of the groove 18 there are two projections 19 which point at one another and which are ultimately used for one of the hook-shaped projections 20 of the connecting profile section 13 to engage the groove 18 of the base profile section 12. At the same time, the hook-shaped projection 21 of the connecting profile section 13 encompasses the free end of the adjacent brace 14. Thus the sections 12, 13 are connected to be able to be inserted into one another and pulled apart from one another,

The connecting profile section 13 has essentially an L-shape, on the outside on one leg there being a sealing means 22 which extends over the entire lengthwise extension of the connecting profile section 13. The base profile section 12, on the outside on the brace 16, has a has a sealing means 22 which extends over the entire length of the base profile section 12. The sealing means 22 can be an adhesive strip of foamed plastic which rests with its adhesive side on the respective rail. The arrangement of the sealing means 22, which are likewise arranged in the manner as shown in FIG. 2 for the support rail 5 and the floor rail 8, aids in positioning the rails 3, 5, 8, for the embodiment shown in FIG. 1, directly adjoining the ceiling 4, the walls 7 and the floor 9 of the space. Therefore, between the ceiling 4 of the space, the walls 7, the floor 9 and the rectangular frame 11 shown in FIG. 1, there are no gaps at all through which fine dust can penetrate.

To connect the base profile section 12 to elements still to be detailed, there are extensions 23 lengthwise along the braces 14. Conversely the extensions 24 on the connecting profile section 13 are used mainly to increase the stiffness of the connecting profile section 13 and to support the fixing means 25 (not yet described). For the base profile section 12 shown in FIG. 2 it is possible to attach at least one connecting profile section 13 at a time on the two lengthwise sides.

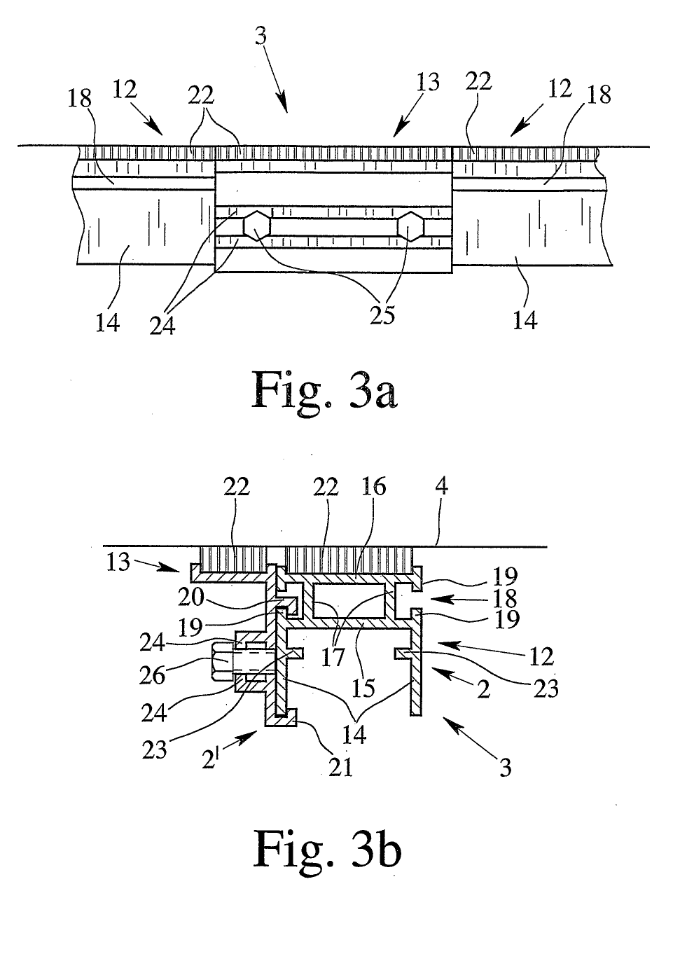

FIGS. 3a & 3b show, using the example of a ceiling rail 3, the fixing of the rail parts 2, 6, 10 to one another, which can be provided in the same way, fundamentally, for all rails 3, 5, 8. FIG. 3a shows a connecting profile section 13 with two fixing means 25, by which one base profile section 12 at a time is fixed to the connecting profile section 13 relative to one another in order to prevent the base profile section 12 and the connecting profile section 13 from slipping into one another or pulling apart from one another. The fixing of the profile sections 12, 13 by a squeeze connection by means of a headless screw 26 is shown in particular in FIG. 3b.

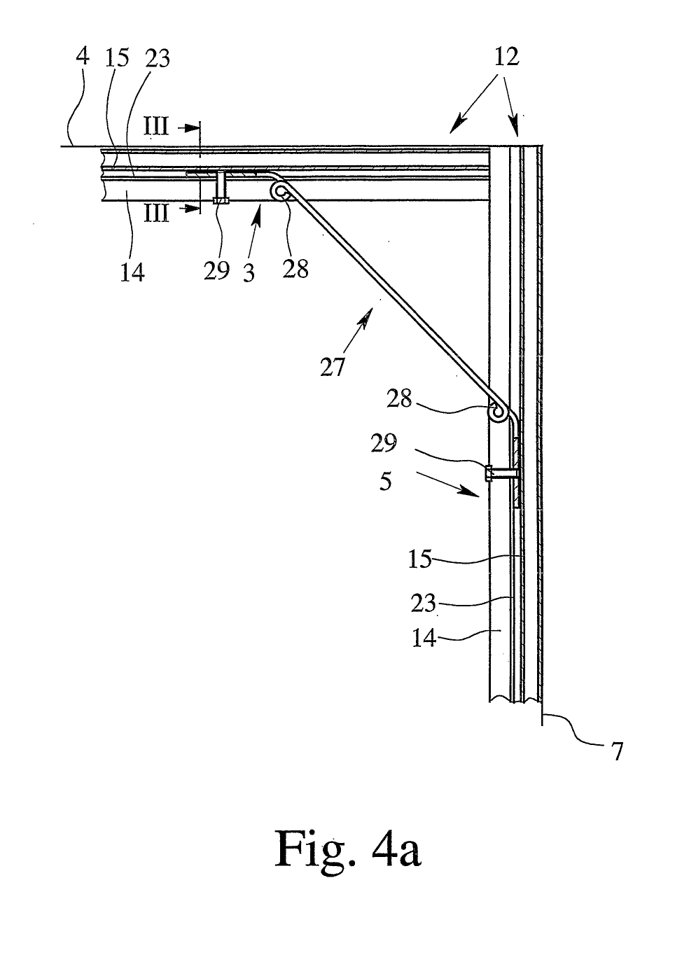

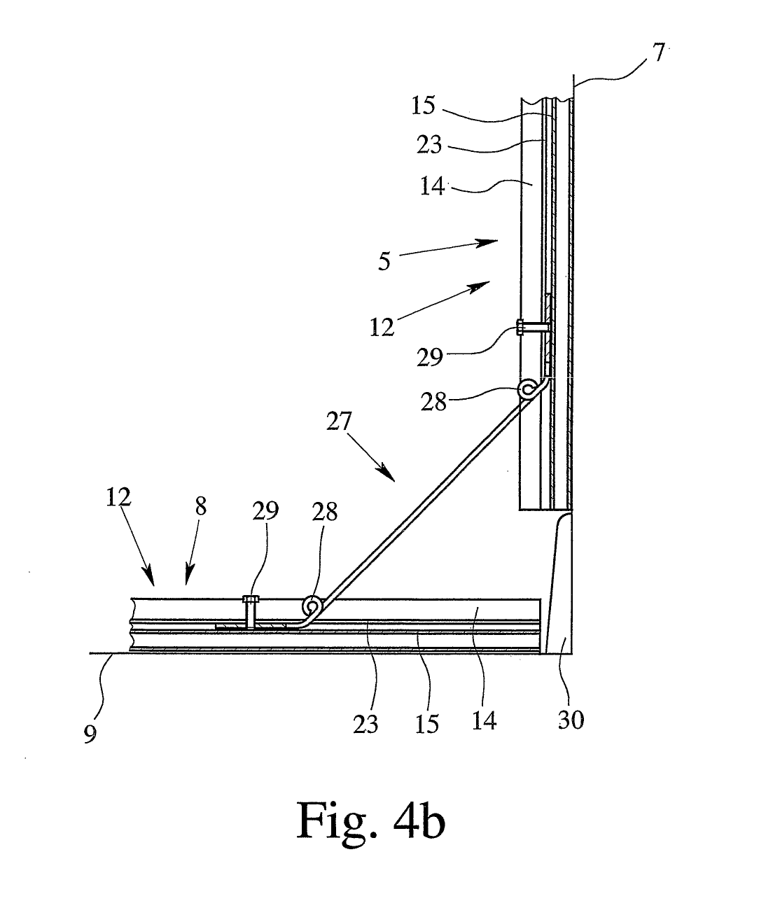

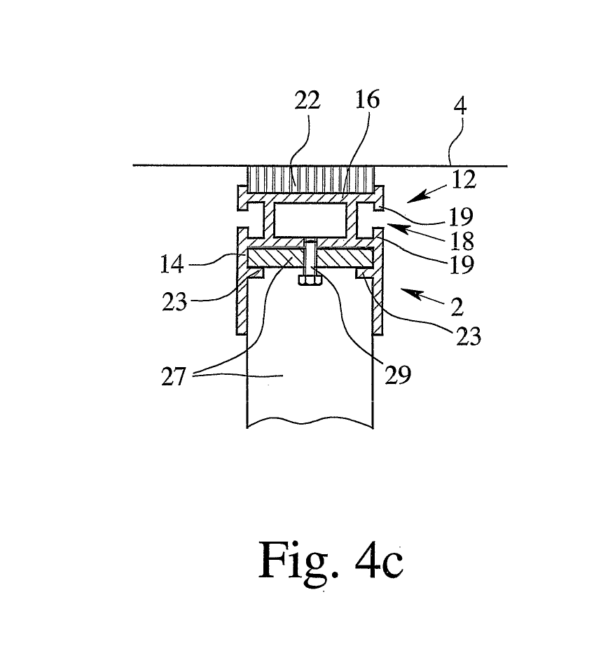

FIGS. 4a & 4b show the connection of two rails 3, 5, 8 via a corner connector 27. It will be appreciated that in all four corners of the frame 11 there can be one corner connector 27. Basically, it makes no difference whether the support rail 5 is connected to a ceiling rail 3 or a floor rail 8. The corner connector 27 shown in FIG. 4a has two spring means 28 which press the ceiling rail 3 and the support rail 5 apart and thus press them against the bordering corner formed from the ceiling 4 of the space and the wall 7. FIG. 4a furthermore shows that the ceiling rail 3 and the support rail 5 are pulled so far apart that their ends touch and “seal” the corner between the ceiling 4 of the space and the wall 7. To connect the corner connector 27 to the rail 3, 5, 8 the lengthwise ends of the corner connector 27, as is shown in FIG. 4c, are inserted between the cross brace 15 and the extensions 23, after which the headless screw 29 is tightened. The corner connectors 27 can thus be located almost anywhere along the base profile section 12. This makes it possible for the frame 11 in the direction of be easily mounted when on the walls 7 there are, for example, floor strips 30 or the like, as is shown in FIG. 4b.

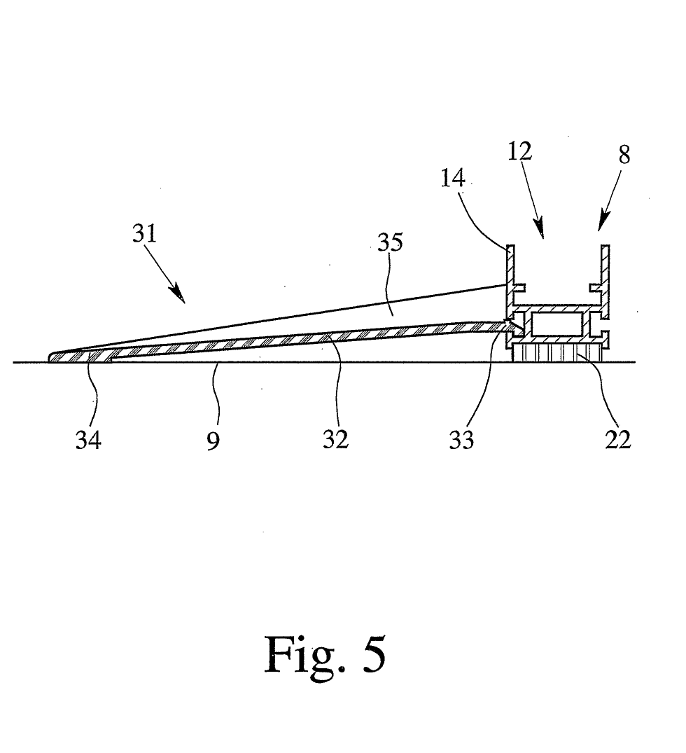

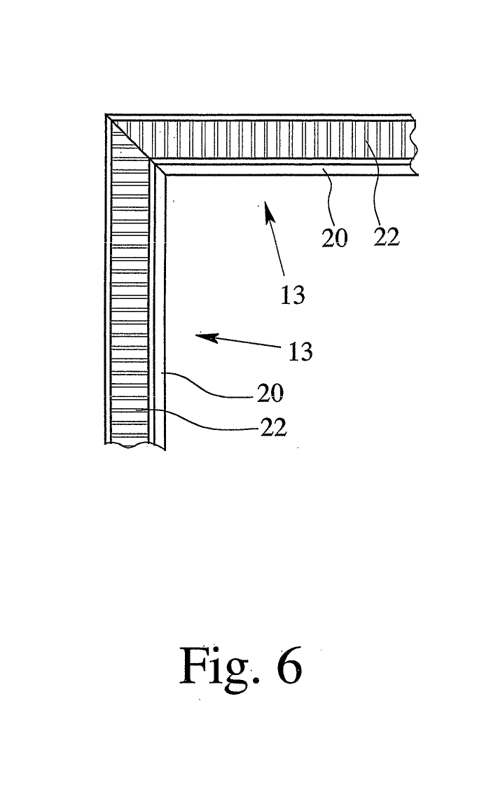

FIG. 5 shows a foot part 31 which is connected to the floor rail 8 for mounting of the frame 11. The foot part 31 has an essentially right-angled base element 32 with a projection 33 on the transverse side for engaging the groove 18. The connection between the foot part 31 and the floor rail 8 takes place either by suspending or inserting the projection 33 into the groove 18 of the floor rail 8. On the transverse side of the foot part 31 facing away from the projection 33 there is a flattened section 34 which establishes contact between the foot part 31 and the floor 9. The two transverse sides of the foot part are spaced roughly 1.4 m apart. During installation of the frame 11, the floor rail 8 is supported on the support element 35 which projects transversely to the base element 32.

To separate the regions of the space over a corner, i.e., to separate regions of a space by means of barriers which have sides aligned preferably at right angles to one another, the connecting profile sections 13, shown in FIG. 6 in a top view, are used. The illustrated connecting profile sections 13 on one lengthwise side end each have a bevel angled by roughly 45° so that two rails 3, 5, 8 which are brought into contact with the end of the bevel have an angle of 90°.

1. Device for separating zones of a room, including a ceiling rail which has at least two ceiling rail parts for pressing against the ceiling of the space, wherein the ceiling rail parts have a profile section such that adjacent ceiling rail parts can be inserted into one another and pulled apart from one another in the lengthwise direction, whereby by mutually shifting the ceiling rail parts in the lengthwise direction the total width of the ceiling rail in the direction of the width of the ceiling of the space can be adjusted to make available a ceiling rail which extends over the entire width of the space.

2. Device as claimed in claim 1, including at least one support rail for supporting the ceiling rail, support rail has at least two support rail parts and adjacent support rail parts can be inserted into one another and pulled apart from one another.

3. Device as claimed in claim 2, wherein said room has a floor and including a floor rail which has at least two floor rail parts for resting on the floor and wherein adjacent floor rail parts can be inserted into one another and pulled apart from one another.

4. Device as claimed in claim 3, wherein the room includes two walls extending from the floor and supporting the ceiling and the ceiling rail, two support rails and the floor rail in the mounted state form a peripheral rectangular frame, the support rails each adjoining the walls of the space.

5. Device as claimed in claim 4, wherein the ceiling rail, the support rail and the floor rail are built identically, wherein each of the ceiling rail, the support rail and the floor rail comprise at least two different profile section rails, a base profile section and a connecting profile section, and the base profile section is made such that two opposing sides of the base profile section (can be connected to at least one connecting profile section at a time.

6. Device as claimed in claim 4, wherein at least one of the ceiling rail, the support rail and the floor rail on the outer sides have a sealing means which extends substantially over the entire rail length for contact with the ceiling, the floor and the wall of the space, respectively.

7. Device as claimed in claim 4, wherein at least one rail part has at least one, fixing means for fixing at least one other rail part relative to one another by a.

8. Device as claimed in claim 4, wherein two rails defining a corner are connected to one another via at least one corner connector having two lengthwise ends and wherein the corner connector has at least one spring means, the spring force of the spring means opposes the approach of the two lengthwise ends of the corner connector to one another.

9. Device 4 as claimed in claim 4 wherein at least one foot part is connected to the floor rail for installation of the device and wherein the foot part, in the connected state, extends over 1 m to 2 m transversely to the floor rail.

10. Device as claimed in claim 5 wherein the connecting profile section, has a bevel angled at an angle of about 45°, at least on one of the lengthwise side ends, and has a length between 50 mm and 500 mm.

11. Device as claimed in claim 2, wherein there are two support rails for supporting the ceiling rail.

12. Device, as claimed in claim 9, wherein the foot part extends about 1.4 m transversely to the floor rail.

13. Device, as claimed in claim 10, wherein the connecting profile section has a length between 100 mm and 300 mm.

14. Device, as claimed in claim 5, wherein at least one of the height and width of at least one of the profile sections is between 15 mm and 45 mm.
